(19) United States
(12) Patent Application Publication
(10) Pub. No.: US 2023/0247987 A1
(43) Pub. Date: Aug. 10, 2023

(54) THE USE OF SAFENERS TO IMPROVE TOLERANCE OF ACCASE TOLERANT SORGHUM CROP TO HERBICIDES

(71) Applicant: Adama Agan Ltd., Ashdod (IL)

(72) Inventors: Andy KENDIG, Chesterfield, MO (US); David FEIST, Fort Collins, CO (US)

(73) Assignee: Adama Agan Ltd., Ashdod (IL)

(21) Appl. No.: 18/012,409

(22) PCT Filed: Jun. 17, 2021
(86) PCT No.: PCT/IL2021/050741

§ 371 Date: Dec. 22, 2022

Related U.S. Application Data
(60) Provisional application No. 63/042,019, filed on Jun. 22, 2020.

(51) Int. Cl. A01N 25/32; A01P 13/02; A01N 43/80

(52) U.S. Cl. CPC A01N 25/32; A01P 13/02; A01N 43/80

(57) ABSTRACT

The subject invention provides a method of controlling undesired vegetation in the vicinity of an ACCase tolerant sorghum crop comprising applying a) an effective amount of an ACCase inhibiting herbicide; and b) an effective amount of isoxadifen, esters, or salts thereof to a locus of the undesired vegetation so as to effectively control the undesired vegetation.

This application claims benefit of U.S. Provisional Application No. 63/042,019, filed Jun. 22, 2020, the entire content of which is hereby incorporated by reference herein.

Throughout this application various publications are referenced. The disclosures of these documents in their entireties are hereby incorporated by reference into this application in order to more fully describe the state of the art to which this invention pertains.

### TECHNICAL FIELD

The present invention provides methods for controlling undesired vegetation in the vicinity of an ACCase tolerant sorghum crop.

### BACKGROUND

Controlling undesired vegetation is extremely important in achieving high crop efficiency. In many cases, however, herbicides that are effective in eradicating a spectrum of weeds are also damaging to the crop. To protect the crop from the negative effects of herbicides and to increase the tolerance of the crop to the herbicides, safeners are often used.

Safeners usually work by inducing expression of genes that code for enzymes involved in herbicide detoxification which leads to more rapid degradation of herbicides so that a damaging concentration is not reached. Various chemicals are known as safeners for different herbicides and crops. Examples of safeners are isoxadifen, cloquintocet, AD-67, benoxacor and fenclorim, and esters thereof. However, safeners may also reduce the sensitivity of the weeds to the herbicides. It is thus a challenging task to find the right equilibrium between safening the desired crop from the deleterious effects of an herbicide, whilst effectively controlling undesired weeds.

Aryloxyphenoxypropionate (FOPs) is a class of herbicides that act by inhibiting acetyl CoA carboxylase (ACCase) which leads to the inhibition of fatty acid biosynthesis. Examples of FOPs, i.e. ACCase inhibiting herbicides, include clodinafop-propargyl, cyhalofop-butyl, diclofop-methyl, fluazifop-butyl, haloxyfop, propaquizafop ((R)-2-[[(1-methylethylidene)amino]oxy]ethyl 2-[4-[(6-chloro-2-quinoxalinyl)oxy]phenoxy]propanoate, first reported by P. F. Bocion et al. (Proc. 1987 Br. Crop Prot. Conf.—Weeds, 1, 55)), and quizalofop ((2-isopropylideneamino-oxyethyl (R) -2-[4-(6-chloroquinoxalin-2-yloxy) phenoxy] propionate, first reported by G. Sakata et al. (Proc. 10^{th} Int. Congr. Plant Prot. 1983, 1, 315)).

Postemergence control options for grassy weeds are limited, and Sorghum-species weeds (Johnsongrass and shattercane) are common and essentially tolerate all grain-sorghum herbicides. Weeds in sorghum compete with sorghum crop for nutrients, water and space. Current weed control methods in Sorghum are expensive, time-consuming and usually do not lead to a total eradication of grass weeds. Preemergence herbicide provide temporary control of grasses, but often there are late-season escapes. And, again, there are no controls for shattercane, nor Johnsongrass. Incomplete control is problematic because even a small amount of remaining weed can produce enough seeds to restore original soil seed bank population levels.

There is a need for efficient and highly selective control of weeds in sorghum without damaging desirable, commercial sorghum. Accordingly, there is a need to find an herbicidal mixture that effectively controls weeds in sorghum without significantly damaging the sorghum crop.

### SUMMARY

The present invention provides a method of controlling undesired vegetation in the vicinity of an ACCase tolerant sorghum crop comprising applying a) an effective amount of an ACCase inhibiting herbicide; and b) an effective amount of isoxadifen, esters or salts thereof (also referred to as “safener” or the “herbicide safener”) to a locus of the undesired vegetation so as to effectively control the undesired vegetation.

The present invention also provides a method of reducing phytotoxic action of an ACCase inhibiting herbicide on an ACCase tolerant sorghum crop, wherein the method comprises applying an effective amount of isoxadifen, esters or salts thereof isoxadifen, esters or salts thereof to the ACCase tolerant sorghum crop so as to effectively reduce the phytotoxic action of the ACCase inhibiting herbicide on the ACCase tolerant sorghum crop compared to the phytotoxic action on the same sorghum crop to which isoxadifen, esters or salts thereof was not applied.

The present invention also provides a method of increasing tolerance of an ACCase tolerant sorghum crop to an ACCase inhibiting herbicide comprising applying an effective amount of isoxadifen, esters or salts thereof isoxadifen, esters or salts thereof to the ACCase tolerant sorghum crop so as to thereby increase tolerance of the ACCase tolerant sorghum crop to the ACCase inhibiting herbicide compared to the tolerance of same sorghum crop to which isoxadifen, esters or salts thereof was not applied.

The present invention also provides a method for reducing herbicide effects of an ACCase inhibiting herbicides in ACCase tolerant sorghum crop, comprising applying isoxadifen, esters or salts thereof to a plant and/or seed of the ACCase tolerant sorghum crop so as to thereby reduce herbicide effects in the ACCase tolerant sorghum crop compared to the herbicide effects in the same sorghum crop to which isoxadifen, esters or salts thereof was not applied.

The present invention also provides a method for increasing tolerance to an ACCase inhibiting herbicide in ACCase tolerant sorghum crop wherein the ACCase tolerant sorghum crop is treated with isoxadifen, esters or salts thereof.

The present invention also provides an ACCase tolerant sorghum crop with increased tolerance to an ACCase inhibiting herbicide wherein the sorghum crop is treated with isoxadifen, esters or salts thereof.

The present invention also provides an ACCase tolerant sorghum crop with increased tolerance to an ACCase inhibiting herbicide obtainable by treating the sorghum crop with isoxadifen, esters or salts thereof.

The present invention also provides a method of controlling undesired vegetation in the vicinity of an ACCase tolerant sorghum crop comprising (i) applying isoxadifen, esters or salts thereof to a seed of the ACCase tolerant sorghum crop and (ii) applying an effective amount of an ACCase inhibiting herbicide to a locus of the undesired vegetation so as to effectively control the undesired vegetation.

### BRIEF DESCRIPTION OF THE DRAWINGS

FIG. 1 shows the safening effect of isoxadifen of an ACCase tolerant sorghum after application of quizalofop-ethyl.

### DETAILED DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the phrase “agriculturally acceptable carrier” means carriers which are known and accepted in the art for the formation of formulations for agricultural or horticultural use.

As used herein, the term “crop” includes reference to a whole plant, plant organ (e.g., leaves, stems, twigs, roots, trunks, limbs, shoots, fruits etc.), plant cells, or plant seeds. This term encompasses plant crops such as fruits. The term also encompasses plant propagation materials, which may include seeds and spores, and vegetative structures such as bulbs, corms, tubers, rhizomes, roots stems, basal shoots, stolons, and buds.

As used herein, the term “ACCase tolerant sorghum crop” refers to a mutant line of sorghum crop which is tolerant or partially tolerant to a specific ACCase herbicide. ACCase tolerant sorghum crop includes genetically modified and non-genetically modified sorghum crops. Non-genetically modified ACCase tolerant sorghum crops may be obtained by techniques such as selection.

ACCase tolerant sorghum crop refers to any sorghum variety having a resistance to one or more acetyl CoA carboxylase inhibiting herbicides. A non-limitative list of sorghum varieties suitable in the methods of the present invention is disclosed in pages 5 to 8 and 23 to 26 of WO 2018/222715, in the name of Chromatin Inc. Preferably, the ACCase tolerant sorghum plant used in the methods of the invention is one wherein the nucleotide sequence encoding the CT domain of the ACC protein comprises one of the following sequences as disclosed in WO 2018/222715: the nucleotide sequence denoted herein by SEQ ID NO: 1 (SEQ ID NO: 2 of WO 2018/222715); the nucleotide sequence denoted herein by SEQ ID NO: 2 (SEQ ID NO: 3 of WO 2018/222715); the nucleotide sequence denoted herein by SEQ ID NO: 3 (SEQ ID NO: 4 of WO 2018/222715); the nucleotide sequence denoted herein by SEQ ID NO: 4 (SEQ ID NO: 5 of WO 2018/222715); the nucleotide sequence of SEQ ID NO: 1, the nucleotide sequence of SEQ ID NO: 2, SEQ ID NO: 3 or SEQ ID NO: 4; the nucleotide sequence of SEQ ID NO: 2 and one of the following: the nucleotide sequence of SEQ ID NO: 3 or SEQ ID NO: 4; the nucleotide sequence of SEQ ID NO: 3 and SEQ ID NO: 4; the nucleotide sequence of SEQ ID NO: 1, SEQ ID NO: 2 and SEQ ID NO: 3; the nucleotide sequence of SEQ ID NO: 1, SEQ ID NO: 2 and SEQ ID NO: 4; the nucleotide sequence of SEQ ID NO: 1, SEQ ID NO: 3 and SEQ ID NO: 4; or The nucleotide sequence of SEQ ID NO: 2, SEQ ID NO: 3 and SEQ ID NO: 4. Sequences as renumbered are as disclosed in WO 2018/222715.

In another embodiment of the invention, the ACCase tolerant sorghum crop, mutants, seeds, or progeny thereof, suitable in the methods of the present invention is one comprising one or more mutations of the sorghum ACC gene, wherein the ACC gene encodes a sorghum acetyl-CoA protein having a CT domain comprising one or more of the following mutations as disclosed in WO 2018/222715: a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5), or a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5, or an alanine to valine amino acid substitution at an amino acid position 2004, (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5, or a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5 and an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5, or a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5 and an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or a Tryptophan to Cysteine amino acid substitution at an amino acid position 1999 (W1999C; resulting in a CT domain polypeptide having a sequence denoted herein by SEQ ID NO: 6) aligning with the amino acid sequence of a Sorghum wild type CT domain polypeptide sequence denoted herein by SEQ ID NO: 5 and an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5, or a Tryptophan to Serine amino acid substitution at an amino acid position 1999 (W19995; resulting in a CT domain polypeptide having a sequence denoted herein by SEQ ID NO: 7) aligning with the amino acid sequence of a Sorghum wild type CT domain polypeptide sequence denoted herein by SEQ ID NO: 5 and an alanine to valine amino acid substitution at an amino acid position 2004 (A2004V; resulting in a CT domain polypeptide having a sequence denoted herein by SEQ ID NO: 8) aligning with the amino acid sequence of a Sorghum wild type CT domain polypeptide sequence denoted herein by SEQ ID NO: 5 and a Tryptophan to Serine amino acid substitution at an amino acid position 2027 (W20275; resulting in a CT domain polypeptide having a sequence denoted herein by SEQ ID NO: 9) aligning with the amino acid sequence of a Sorghum wild type CT domain polypeptide sequence denoted herein by SEQ ID NO: 5. The nucleotide sequences denoted by SEQ ID NO: 1 through 4 and the amino acid sequences denoted by SEQ ID NO: 5 through 9 are as disclosed in SEQ ID NO: 2 through 5 and SEQ ID NO: 6 through 10 in WO 2018/222715 and as detailed in Table 1 below.

TABLE 1

| SEQ | | Sequences |
|---|---|---|
| ID NO: | Sequence | name |
| 1 | gcaaactctggtgctaggattggcatagctgatgaagtaaaatcttgcttccgtgttggg | Synthetic |
| | tggtctgacgaaggcagccctgagcgagggtttcagtacatctatctgactgaagaaga | Polynucleotide |
| | ctatgcccgtattagctcttctgttatagcacataagctgcagctagatagcggtgaaat | ACC1 (TGG to |
| | taggtggattattgactctgttgtgggcaaggaggatgggcttggtgttgagaacatac | TGC) |
| | atggaagtgctgctatcgccagtgcttattctagggcatatgaggagacatttacactta | |
| | catttgtgaccggacggactgtaggaataggagcttatcttgctagacttggtatacggt | |
| | gcatacagcgtcttgaccagccaattattttaacagggttttctgccctgaacaagctcct | |
| | tgggcgggaagtgtacagctcccacatgcagcttggtggtcctaagatcatggcgacca | |
| | atggtgttgtccacctgactgttccagatgaccttgaaggtgtttccaatatattgaggtg | |
| | gctcagctatgttcctgcaaacattggtggacctcttcctattaccaaacctttggaccct | |
| | ccagacagacctgttgcatacatccctgagaacacatgcgatccacgtgcagccatccg | |
| | tggtgtagatgacagccaagggaaatggttgggtggtatgtttgacaaagacagctttg | |
| | tggagacatttgaaggatgggcaaaaacagtggttactggcagagcaaagcttggag | |
| | gaattcctgtgggtgtcatagctgtggagacacagaccatgatgcagcttgtccctgctg | |
| | atccaggtcagcttgattcccatgagcgatccgttcctcgggctggacaagtgtgcttcc | |
| | cagattctgcaaccaagacagctcaggcattattagacttcaaccgtgaaggattgcct | |
| | ctgtttatcctggctaactggagaggtttctctggtggacagagagatctctttgaagga | |
| | attcttcaggctgggtcaacaattgtcgagaaccttaggacatataatcagcctgcgttt | |
| | gtctacattcctatggctggagagcttcgtggaggagcttgggttgtggtcgatagcaaa | |
| | ataaatccagaccgcattgagtgttatgctgagaggactgccaaaggtaatgttctcga | |
| | acctcaagggttaattgaaatcaagttcaggtcagaggaactccaagactgtatggg | |
| | taggcttgaccccgagttgataaatctgaaagcaaaactccaagatgtaaagcatgga | |
| | aatggaagtctaccagacatagaatcccttcagaagagtatagaagcacgtacgaaac | |
| | agttgctgcctttatatacccagattgcaatacggtttgctgaattgcatgatacttccct | |
| | aagaatggcagctaaaggcgtgattaagaaagttgtagactgggaagaatcacgctct | |
| | ttcttctataaaaggctacggagaaggatctctgaagatgttcttgcaaaagaaataag | |
| | acatatagtcggtgacaacttcactcaccaatcagcaatggagctcatcaaggaatggt | |
| | acctggcttctccagccacagcaggaagcactggatgggatgacgatgatgcatttgtt | |
| | gcctggaaggacagtcctgaaaactacaatggatatatccaagagctaagggctcaaa | |
| | aagtgtctcagtcgctctctgatctcactgactccagttcagatctacaagcattctcgca | |
| | gggtctttctacgctattagataagatggatccctctcaaagagcgaagtttgttcagga | |
| | agtcaagaaggtccttggttga | |
| 2 | gcaaactctggtgctaggattggcatagctgatgaagtaaaatcttgcttccgtgttggg | Synthetic |
| | tggtctgacgaaggcagccctgagcgagggtttcagtacatctatctgactgaagaaga | Polynucleotide |
| | ctatgcccgtattagctcttctgttatagcacataagctgcagctagatagcggtgaaat | ACC2 (TGG to |
| | taggtggattattgactctgttgtgggcaaggaggatgggcttggtgttgagaacatac | TCG) |
| | atggaagtgctgctatcgccagtgcttattctagggcatatgaggagacatttacactta | |
| | catttgtgaccggacggactgtaggaataggagcttatcttgctagacttggtatacggt | |
| | gcatacagcgtcttgaccagccaattattttaacagggttttctgccctgaacaagctcct | |
| | tgggcgggaagtgtacagctcccacatgcagcttggtggtcctaagatcatggcgacca | |
| | atggtgttgtccacctgactgttccagatgaccttgaaggtgtttccaatatattgaggtg | |
| | getcagctatgttcctgcaaacattggtggacctcttcctattaccaaacctttggaccct | |
| | ccagacagacctgttgcatacatccctgagaacacatgcgatccacgtgcagccatccg | |
| | tggtgtagatgacagccaagggaaatggttgggtggtatgtttgacaaagacagctttg | |
| | tggagacatttgaaggatgggcaaaaacagtggttactggcagagcaaagcttggag | |
| | gaattcctgtgggtgtcatagctgtggagacacagaccatgatgcagcttgtccctgctg | |
| | atccaggtcagcttgattcccatgagcgatccgttcctcgggctggacaagtgtcgttcc | |
| | cagattctgcaaccaagacagctcaggcattattagacttcaaccgtgaaggattgcct | |
| | ctgtttatcctggctaactggagaggtttctctggtggacagagagatctctttgaagga | |
| | attcttcaggctgggtcaacaattgtcgagaaccttaggacatataatcagcctgcgttt | |
| | gtctacattcctatggctggagagcttcgtggaggagcttgggttgtggtcgatagcaaa | |
| | ataaatccagaccgcattgagtgttatgctgagaggactgccaaaggtaatgttctcga | |
| | acctcaagggttaattgaaatcaagttcaggtcagaggaactccaagactgtatgggta | |
| | ggcttgaccccgagttgataaatctgaaagcaaaactccaagatgtaaagcatggaaa | |
| | tggaagtctaccagacatagaatcccttcagaagagtatagaagcacgtacgaaacag | |
| | ttgctgcctttatatacccagattgcaatacggtttgctgaattgcatgatacttccctaa | |
| | gaatggcagctaaaggcgtgattaagaaagttgtagactgggaagaatcacgctctttc | |
| | ttctataaaaggctacggagaaggatctctgaagatgttcttgcaaaagaaataagac | |
| | atatagtcggtgacaacttcactcaccaatcagcaatggagctcatcaaggaatggtac | |
| | ctggcttctccagccacagcaggaagcactggatgggatgacgatgatgcatttgttgc | |
| | ctggaaggacagtcctgaaaactacaatggatatatccaagagctaagggctcaaaa | |
| | agtgtctcagtcgctctctgatctcactgactccagttcagatctacaagcattctcgcag | |
| | ggtctttctacgctattagataagatggatccctctcaaagagcgaagtttgttcaggaa | |
| | gtcaagaaggtccttggttga | |
| 3 | gcaaactctggtgctaggattggcatagctgatgaagtaaaatcttgctt ccgtgttggg | Synthetic |
| | tggtctgacgaaggcagccctgagcgagggtttcagtacatctatctgactgaagaaga | Polynucleotide |
| | ctatgcccgtattagctcttctgttatagcacataagctgcagctagatagcggtgaaat | ACC3 (GCA to |
| | taggtggattattgactctgttgtgggcaaggaggatgggcttggtgttgagaacatac | GTA) |
| | atggaagtgctgctatcgccagtgcttattctagggcatatgaggagacatttacactta | |
| | catttgtgaccggacggactgtaggaataggagcttatcttgctagacttggtatacggt | |
| | gcatacagcgtcttgaccagccaattattttaacagggttttctgccctgaacaagctcct | |
| | tgggcgggaagtgtacagctcccacatgcagcttggtggtcctaagatcatggcgacca | |
| | atggtgttgtccacctgactgttccagatgaccttgaaggtgtttccaatatattgaggtg | |
| | gctcagctatgttcctgcaaacattggtggacctcttcctattaccaaacctttggaccct | |
| | ccagacagacctgttgcatacatccctgagaacacatgcgatccacgtgcagccatccg | |
| | tggtgtagatgacagccaagggaaatggttgggtggtatgtttgacaaagacagctttg | |
| | tggagacatttgaaggatgggcaaaaacagtggttactggcagagcaaagcttggag | |
| | gaattcctgtgggtgtcatagctgtggagacacagaccatgatgcagcttgtccctgctg | |
| | atccaggtcagcttgattcccatgagcgatccgttcctcgggctggacaagtgtcgttcc | |
| | cagattctgtaaccaagacagctcaggcattattagacttcaaccgtgaaggattgcct | |
| | ctgtttatcctggctaactggagaggtttctctggtggacagagagatctctttgaagga | |
| | attcttcaggctgggtcaacaattgtcgagaaccttaggacatataatcagcctgcgttt | |
| | gtctacattcctatggctggagagcttcgtggaggagcttgggttgtggtcgatagcaaa | |
| | ataaatccagaccgcattgagtgttatgctgagaggactgccaaaggtaatgttctcga | |
| | acctcaagggttaattgaaatcaagttcaggtcagaggaactccaagactgtatggg | |
| | taggcttgaccccgagttgataaatctgaaagcaaaactccaagatgtaaagcatgga | |
| | aatggaagtctaccagacatagaatcccttcagaagagtatagaagcacgtacgaaac | |
| | agttgctgcctttatatacccagattgcaatacggtttgctgaattgcatgatacttccct | |
| | aagaatggcagctaaaggcgtgattaagaaagttgtagactgggaagaatcacgctct | |
| | ttcttctataaaaggctacggagaaggatctctgaagatgttcttgcaaaagaaataag | |
| | acatatagtcggtgacaacttcactcaccaatcagcaatggagctcatcaaggaatggt | |
| | acctggcttctccagccacagcaggaagcactggatgggatgacgatgatgcatttgtt | |
| | gcctggaaggacagtcctgaaaactacaatggatatatccaagagctaagggctcaaa | |
| | aagtgtctcagtcgctctctgatctcactgactccagttcagatctacaagcattctcgca | |
| | gggtctttctacgctattagataagatggatccctctcaaagagcgaagtttgttcagga | |
| | agtcaagaaggtccttggttga | |
| 4 | gcaaactctggtgctaggattggcatagctgatgaagtaaaatcttgcttccgtgttggg | Synthetic |
| | tggtctgacgaaggcagccctgagcgagggtttcagtacatctatctgactgaagaaga | Polynucleotide |
| | ctatgcccgtattagctcttctgttatagcacataagctgcagctagatagcggtgaaat | ACC4 (TGG to |
| | taggtggattattgactctgttgtgggcaaggaggatgggcttggtgttgagaacatac | TCG) |
| | atggaagtgctgctatcgccagtgcttattctagggcatatgaggagacatttacactta | |
| | catttgtgaccggacggactgtaggaataggagcttatcttgctagacttggtatacggt | |
| | gcatacagcgtcttgaccagccaattattttaacagggttttctgccctgaacaagctcct | |
| | tgggcgggaagtgtacagctcccacatgcagcttggtggtcctaagatcatggcgacca | |
| | atggtgttgtccacctgactgttccagatgaccttgaaggtgtttccaatatattgaggtg | |
| | gctcagctatgttcctgcaaacattggtggacctcttcctattaccaaacctttggaccct | |
| | ccagacagacctgttgcatacatccctgagaacacatgcgatccacgtgcagccatccg | |
| | tggtgtagatgacagccaagggaaatggttgggtggtatgtttgacaaagacagctttg | |
| | tggagacatttgaaggatgggcaaaaacagtggttactggcagagcaaagcttggag | |
| | gaattcctgtgggtgtcatagctgtggagacacagaccatgatgcagcttgtccctgctg | |
| | atccaggtcagcttgattcccatgagcgatccgttcctcgggctggacaagtgtcgttcc | |
| | cagattctgtaaccaagacagctcaggcattattagacttcaaccgtgaaggattgcct | |
| | ctgtttatcctggctaactcgagaggtttctctggtggacagagagatctctttgaagga | |
| | attcttcaggctgggtcaacaattgtcgagaaccttaggacatataatcagcctgcgttt | |
| | gtctacattcctatggctggagagcttcgtggaggagcttgggttgtggtcgatagcaaa | |
| | ataaatccagaccgcattgagtgttatgctgagaggactgccaaaggtaatgttctcga | |
| | acctcaagggttaattgaaatcaagttcaggtcagaggaactccaagactgtatgggta | |
| | ggcttgaccccgagttgataaatctgaaagcaaaactccaagatgtaaagcatggaaa | |
| | tggaagtctaccagacatagaatcccttcagaagagtatagaagcacgtacgaaacag | |
| | ttgctgcctttatatacccagattgcaatacggtttgctgaattgcatgatacttccctaa | |
| | gaatggcagctaaaggcgtgattaagaaagttgtagactgggaagaatcacgctctttc | |
| | ttctataaaaggctacggagaaggatctctgaagatgttcttgcaaaagaaataagac | |
| | atatagtcggtgacaacttcactcaccaatcagcaatggagctcatcaaggaatggtac | |
| | ctggcttctccagccacagcaggaagcactggatgggatgacgatgatgcatttgttgc | |
| | ctggaaggacagtcctgaaaactacaatggatatatccaagagctaagggctcaaaa | |
| | agtgtctcagtcgctctctgatctcactgactccagttcagatctacaagcattctcgcag | |
| | ggtctttctacgctattagataagatggatccctctcaaagagcgaagtttgttcaggaa | |
| | gtcaagaaggtccttggttga | |
| 5 | ANSGARIGIADEVKSCFRVGWSDEGSPERGFQYIYLTEEDYA | Sorghum Wild |
| | RISSSVIAHKLQLDSGEIRWIIDSVVGKEDGLGVENIHGSAA | type CT |
| | IASAYSRAYEETFTLTFVTGRTVGIGAYLARLGIRCIQRLDQ | domain |
| | PIILTGFSALNKLLGREVYSSHMQLGGPKIMATNGVVHLTVP | sequence |
| | DDLEGVSNILRWLSYVPANIGGPLPITKPLDPPDRPVAYIPE | |
| | NTCDPRAAIRGVDDSQGKWLGGMFDKDSFVETFEGWAKTVVT | |
| | GRAKLGGIPVGVIAVETQTMMQLVPADPGQLDSHERSVPRAG | |
| | QVWFPDSATKTAQALLDENREGLPLFILANWRGFSGGQRDLF | |
| | EGILQAGSTIVENLRTYNQPAFVYIPMAGELRGGAWVVVDSK | |
| | INPDRIECYAERTAKGNVLEPQGLIEIKFRSEELQDCMGRLD | |
| | PELINLKAKLQDVKHGNGSLPDIESLQKSIEARTKQLLPLYT | |
| | QIAIRFAELHDTSLRMAAKGVIKKVVDWEESRSFFYKRLRRR | |
| | ISEDVLAKEIRHIVGDNFTHQSAMELIKEWYLASPATAGSTG | |
| | WDDDDAFVAWKDSPENYNGYIQELRAQKVSQSLSDLTDSSSD | |
| | LQAFSQGLSTLLDKMDPSQRAKFVQEVKKVLG | |
| 6 | ANSGARIGIADEVKSCFRVGWSDEGSPERGFQYIYLTEEDYA | Synthetic |
| | RISSSVIAHKLOLDSGEIRWIIDSVVGKEDGLGVENIHGSAA | Polypeptide, |
| | IASAYSRAYEETFTLTFVTGRTVGIGAYLARLGIRCIQRLDQ | ACC1 |
| | PIILTGFSALNKLLGREVYSSHMQLGGPKIMATNGVVHLTVP | (W1999C) |
| | DDLEGVSNILRWLSYVPANIGGPLPITKPLDPPDRPVAYIPE | |
| | NTCDPRAAIRGVDDSQGKWLGGMFDKDSFVETFEGWAKTVVT | |
| | GRAKLGGIPVGVIAVETQTMMQLVPADPGQLDSHERSVPRAG | |
| | QVCFPDSATKTAQALLDENREGLPLFILANWRGFSGGQRDLF | |
| | EGILQAGSTIVENLRTYNQPAFVYIPMAGELRGGAWVVVDSK | |
| | INPDRIECYAERTAKGNVLEPQGLIEIKFRSEELQDCMGRLD | |
| | PELINLKAKLQDVKHGNGSLPDIESLQKSIEARTKQLLPLYT | |
| | QIAIRFAELHDTSLRMAAKGVIKKVVDWEESRSFFYKRLRRR | |
| | ISEDVLAKEIRHIVGDNFTHQSAMELIKEWYLASPATAGSTG | |
| | WDDDDAFVAWKDSPENYNGYIQELRAQKVSQSLSDLTDSSSD | |
| | LQAFSQGLSTLLDKMDPSQRAKFVQEVKKVLG | |
| 7 | ANSGARIGIADEVKSCFRVGWSDEGSPERGFQYTYLTEEDYA | Synthetic |
| | RISSSVIAHKLQLDSGEIRWIIDSVVGKEDGLGVENIHGSAA | Polypeptide, |
| | IASAYSRAYEETFTLTEVTGRTVGIGAYLARLGIRCIQRLDQ | ACC2 |
| | PIILTGFSALNKLLGREVYSSHMQLGGPKIMATNGVVHLTVP | (W1999S) |
| | DDLEGVSNILRWLSYVPANIGGPLPITKPLDPPDRPVAYIPE | |
| | NTCDPRAAIRGVDDSQGKWLGGMFDKDSFVETFEGWAKTVVT | |
| | GRAKLGGIPVGVIAVETQTMMQLVPADPGQLDSHERSVPRAG | |
| | QVSFPDSATKTAQALLDENREGLPLFILANWRGFSGGQRDLF | |
| | EGILQAGSTIVENLRTYNQPAFVYIPMAGELRGGAWVVVDSK | |
| | INPDRIECYAERTAKGNVLEPQGLIEIKFRSEELQDCMGRLD | |
| | PELINLKAKLQDVKHGNGSLPDIESLQKSIEARTKQLLPLYT | |
| | QIAIRFAELHDTSLRMAAKGVIKKVVDWEESRSFFYKRLRRR | |
| | ISEDVLAKEIRHIVGDNFTHQSAMELIKEWYLASPATAGSTG | |
| | WDDDDAFVAWKDSPENYNGYIQELRAQKVSQSLSDLTDSSSD | |
| | LQAFSQGLSTLLDKMDPSQRAKFVQEVKKVLG | |
| 8 | ANSGARIGIADEVKSCFRVGWSDEGSPERGFQYIYLTEEDYA | Synthetic |
| | RISSSVIAHKLQLDSGEIRWIIDSVVGKEDGLGVENIHGSAA | Polypeptide, |
| | IASAYSRAYEETFTLTFVTGRTVGIGAYLARLGIRCIQRLDQ | ACC3 |
| | PIILTGFSALNKLLGREVYSSHMQLGGPKIMATNGVVHLTVP | (A2004V) |
| | DDLEGVSNILRWLSYVPANIGGPLPITKPLDPPDRPVAYIPE | |
| | NTCDPRAAIRGVDDSQGKWLGGMFDKDSFVETFEGWAKTVVT | |
| | GRAKLGGIPVGVIAVETQTMMQLVPADPGQLDSHERSVPRAG | |
| | QVWFPDSVTKTAQALLDENREGLPLFILANWRGFSGGQRDLF | |
| | INPDRIECYAERTAKGNVLEPQGLIEIKFRSEELQDCMGRLD | |
| | PELINLKAKLQDVKHGNGSLPDIESLQKSIEARTKOLLPLYT | |
| | QIAIRFAELHDTSLRMAAKGVIKKVVDWEESRSFFYKRLRRR | |
| | ISEDVLAKEIRHIVGDNFTHQSAMELIKEWYLASPATAGSTG | |
| | WDDDDAFVAWKDSPENYNGYIQELRAQKVSQSLSDLTDSSSD | |
| | LQAFSQGLSTLLDKMDPSQRAKFVQEVKKVLG | |
| | EGILQAGSTIVENLRTYNQPAFVYIPMAGELRGGAWVVVDSK | |
| 9 | ANSGARIGIADEVKSCFRVGWSDEGSPERGFQYIYLTEEDYA | Synthetic |
| | RISSSVIAHKLQLDSGEIRWIIDSVVGKEDGLGVENIHGSAA | Polypeptide, |
| | IASAYSRAYEETFTLTFVTGRTVGIGAYLARLGIRCIQRLDQ | ACC4 |
| | PIILTGFSALNKLLGREVYSSHMQLGGPKIMATNGVVHLTVP | (W2027S) |
| | DDLEGVSNILRWLSYVPANIGGPLPITKPLDPPDRPVAYIPE | |
| | NTCDPRAAIRGVDDSQGKWLGGMFDKDSFVETFEGWAKTVVT | |
| | GRAKLGGIPVGVIAVETQTMMQLVPADPGQLDSHERSVPRAG | |
| | QVWFPDSATKTAQALLDENREGLPLFILANSRGFSGGQRDLF | |
| | EGILQAGSTIVENLRTYNQPAFVYIPMAGELRGGAWVVVDSK | |
| | INPDRIECYAERTAKGNVLEPQGLIEIKFRSEELQDCMGRLD | |
| | PELINLKAKLQDVKHGNGSLPDIESLQKSIEARTKQLLPLYT | |
| | QIAIRFAELHDTSLRMAAKGVIKKVVDWEESRSFFYKRLRRR | |
| | ISEDVLAKEIRHIVGDNFTHQSAMELIKEWYLASPATAGSTG | |
| | WDDDDAFVAWKDSPENYNGYIQELRAQKVSQSLSDLTDSSSD | |
| | LQAFSQGLSTLLDKMDPSQRAKFVQEVKKVLG | |

In another embodiment, the ACCase tolerant sorghum crop, mutants, seeds, or progeny thereof, is selected from one that comprises in its genome at least one polynucleotide encoding a polypeptide having a Tryptophan to Cysteine amino acid substitution at an amino acid position 1999 (SEQ ID NO: 6; W1999C) aligning with SEQ ID NO: 5; a Tryptophan to Serine amino acid substitution at an amino acid position 1999 (SEQ ID NO: 7; W1999S) aligning with SEQ ID NO: 5; an Alanine to Valine amino acid substitution at an amino acid position 2004 (SEQ ID NO: 8; A2004V) aligning with SEQ ID NO: 5; and a Tryptophan to Serine amino acid substitution at an amino acid position 2027 (SEQ ID NO: 9; W2027S) aligning with SEQ ID NO: 5 of sorghum Acetyl-CoA Carboxylase large subunit, wherein the sequences are as disclosed in WO 2018/222715 and as detailed in Table 1 above.

In another embodiment, the ACCase tolerant sorghum crop, mutants, seeds, or progeny thereof, is one selected from the deposit under ATCC Accession No. PTA-125106 (sorghum line BTX430-CHR-ACC1), and, PTA-125107 (sorghum line BTX430-CHR-ACC4) or PTA-125108 (sorghum line BTX430-CHR-ACC2), deposited on May 9, 2018 with the American Type Tissue Culture Collection (ATCC) under the terms of the Budapest Treaty.

As used herein, the term “locus” includes not only areas where undesired vegetation may already be growing, but also areas where undesired vegetation has yet to emerge and areas under cultivation.

As used herein, the term “post-emergence,” refers to the application of the herbicidal mixtures or compositions to the undesired vegetation that has emerged from the soil. The term “pre-emergence” refers to the application of the herbicidal mixtures or compositions to a habitat, an undesired vegetation, or soil, prior to the emergence of the undesired vegetation from the soil.

As used herein, the term “control of undesired vegetation” refers to the interference with the normal growth and development of the undesired vegetation. Examples of control activity include, but are not limited to, inhibition of root growth, inhibition of shoot growth, inhibition of shoot emergence, inhibition of seed production, or reduction of biomass of the undesired vegetation.

As used herein, the term “effective” when used to describe a method for controlling of undesired vegetation means that the method provides a good level of control of the undesired vegetation without significantly interfering with the normal growth and development of the crop.

As used herein, the term “effective amount” refers to an amount of the mixture that, when absorbed, contacted with or sensed, is sufficient to achieve a good level of control.

As used herein, the term “surfactant” refers to any agriculturally acceptable material which imparts emulsifiability, stability, spreading, wetting, dispersibility, or other surface-modifying properties.

As used herein, the term “mixture” or “combination” refers, but is not limited to, a combination in any physical form, e.g., blend, solution, alloy, or the like.

As used herein, the term “a” or “an” as used herein includes the singular and the plural, unless specifically stated otherwise. Therefore, the terms “a,” “an” or “at least one” can be used interchangeably in this application.

As used herein, the term “about” when used in connection with a numerical value includes ±10% from the indicated value. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “0.1-99 wt. %” includes 0.1 wt. %, 0.2 wt. %, 0.3 wt. %, etc. up to 99 wt. %.

As used herein, the term “low light intensity” when used in connection with growing conditions for sorghum crop means that the light intensity is less than 300 μM/m2/sec. Preferably, the light intensity is less than 150 μM/m2/sec.

As used herein, the term “high light intensity” when used in connection with growing conditions for sorghum crop means that the light intensity is greater than 700 μM/m2/sec. Preferably, the light intensity is between 800 μM/m2/sec to 1000 μM/m2/sec.

The subject invention relates to the use of safener(s) to enhance tolerance of ACCase tolerant sorghum crop to ACCase herbicides such that application of the ACCase herbicides produces less phytotoxicity on the ACCase tolerant sorghum crop compared to the herbicide effects in the same sorghum crop to which isoxadifen, esters or salts thereof was not applied. Preferably, the subject invention relates to the use of safener(s) to enhance tolerance of ACCase tolerant sorghum crop to ACCase herbicides such that application of the ACCase herbicides will not significantly damage the ACCase tolerant sorghum crop.

The methods of the invention can be put in practice by applying an herbicidal mixture in the vicinity of the ACCase tolerant sorghum crop, wherein the herbicidal mixture comprises a) an acetyl CoA carboxylase (ACCase) inhibiting herbicide; and b) isoxadifen, esters or salts thereof.

ACCase inhibiting herbicides may include but are not limited to propaquizafop, quizalofop, quizalofop-P-ethyl, quizalofop-P-terfuryl, quiazlofop-P-methyl, and fluazifop-p and ester derivatives thereof. In some embodiments, the ACCase inhibiting herbicide is propaquizafop. In some embodiments, the ACCase inhibiting herbicide is quizalofop.

In some embodiments, the weight ratio of the ACCase herbicide to isoxadifen, esters or salts thereof in the herbicidal mixture is from 1:4 to 10:1. In some embodiments, the weight ratio of the ACCase herbicide to isoxadifen, esters or salts thereof in the herbicidal mixture is 1:4 or 1:3 or 1:2 or 1:1 or 2:1 or 3:1 or 4:1 or 5:1 or 6:1, or 7:1 or 8:1 or 9:1 or 10:1.

In some embodiments, the herbicidal mixture comprises from about 0.1% to about 99% by weight of the ACCase herbicide. In some embodiments, the herbicidal mixture comprises from about 0.1% to about 25% by weight of the ACCase herbicide. In some embodiments, the herbicidal mixture comprises from about 25% to about 50% by weight of the ACCase herbicide. In some embodiments, the herbicidal mixture comprises from about 50% to about 75% by weight of the ACCase herbicide. In some embodiments, the herbicidal mixture comprises from about 75% to about 99% by weight of the ACCase herbicide.

In some embodiments, the herbicidal mixture comprises from about 0.1% to about 90% by weight of isoxadifen, esters or salts thereof. In some embodiments, the herbicidal mixture comprises from about 0.1% to about 25% by weight of the safener isoxadifen, esters or salts thereof. In some embodiments, the herbicidal mixture comprises from about 25% to about 50% by weight of isoxadifen, esters or salts thereof. In some embodiments, the herbicidal mixture comprises from about 50% to about 75% by weight of isoxadifen, esters or salts thereof. In some embodiments, the herbicidal mixture comprises from about 75% to about 90% by weight of isoxadifen, esters or salts thereof.

In some embodiments, the ACCase tolerant sorghum crop has at least one genetic mutation that confers tolerance or partial tolerance to ACCase inhibiting herbicides.

In some embodiments, the ACCase tolerant sorghum crop is tolerant to an ACCase and isoxadifen, esters or salts thereof is effective for increasing the tolerance of the ACCase tolerant sorghum crop to the ACCase inhibiting herbicide.

In some embodiments, the ACCase tolerant sorghum crop is tolerant to an ACCase inhibiting herbicide and isoxadifen, esters or salts thereof is effective for increasing the tolerance of the ACCase tolerant sorghum crop to the ACCase inhibiting herbicide in the herbicidal mixture.

In some embodiments, the combination of isoxadifen, esters or salts thereof and the mutation in the ACCase tolerant sorghum crop is effective for increasing the ED50 of the ACCase herbicide.

In some embodiments, isoxadifen, esters or salts thereof, when applied to the ACCase tolerant sorghum crop, is effective for increasing the ED50 of the ACCase herbicide.

In some embodiments, the ACCase tolerant sorghum crop contains 1, or 2, or 3 or more genes that confer tolerance to ACCase inhibiting herbicides.

In some embodiments, the undesired vegetation is monocots. Examples of weed species on which the application according to present invention act efficiently are, from amongst the monocotyledonous weed species, including, but not limited to: Avena spp., Alopecurus spp., Apera spp., Brachiaria spp., Bromus spp., Chenchrus spp., Digitaria spp., Lolium spp., Echinochloa spp., Panicum spp., Phalaris spp., Poa spp., Setaria spp. and among the perennial species, Agropyron, Cynodon, Imperata and Sorghum.

In some embodiments, environmental conditions affect the degree of tolerance of the ACCase tolerant sorghum crop to the ACCase inhibiting herbicide. In some embodiments, the degree of tolerance of the ACCase tolerant sorghum crop to the ACCase inhibiting herbicide is reduced when the ACCase tolerant sorghum crop is grown under low light intensity conditions compared to high light intensity conditions.

In some embodiments, the isoxadifen, esters or salts thereof is effective in reducing phytotoxic action of the ACCase herbicide on the ACCase tolerant sorghum crop grown under low light intensity conditions. In some embodiments, the isoxadifen, esters or salts thereof is effective in reducing phytotoxic action of the ACCase herbicide on the ACCase tolerant sorghum crop grown under high light intensity conditions.

In some embodiments, the isoxadifen, esters or salts thereof is effective in increasing tolerance of the ACCase tolerant sorghum crop grown under low light intensity conditions. In some embodiments, the isoxadifen, esters or salts thereof is effective in increasing tolerance of the ACCase tolerant sorghum crop grown under high light intensity conditions.

In some embodiments, environmental condition may include but are not limited to light intensity and temperature.

Degree of herbicide tolerance of a crop is influenced by its growth and metabolism rate.

For example, under low light intensity condition such as cloudy or foggy and/or at low temperatures such as less than 65° F., the crop growth and metabolism rate is reduced and therefore the herbicidal tolerance of the crop is decreased.

In some embodiments, isoxadifen, esters or salts thereof is effective for reducing the phytotoxic action of the ACCase herbicide on the ACCase tolerant sorghum crop by at least 10% compared to phytotoxic action of the herbicide on the same sorghum crop to which isoxadifen, esters or salts thereof was not applied. In some embodiments, isoxadifen, esters or salts thereof is effective for reducing the phytotoxic action of the ACCase herbicide on the ACCase tolerant sorghum crop by at least 15% compared to the phytotoxic action of the herbicide on the same sorghum crop to which isoxadifen, esters or salts thereof was not applied. In some embodiments, isoxadifen, esters or salts thereof is effective for reducing the phytotoxic action of the ACCase herbicide on the ACCase tolerant sorghum crop by at least 20% compared to the phytotoxic action of the herbicide on the same sorghum crop to which isoxadifen, esters or salts thereof was not applied.

In some embodiments, isoxadifen, esters or salts thereof is effective for increasing the tolerance of the ACCase tolerant sorghum crop to the ACCase herbicide by at least 10% compared to the tolerance of the same sorghum crop to which isoxadifen, esters or salts thereof was not applied. In some embodiments, isoxadifen, esters or salts thereof is effective for increasing the tolerance of the ACCase tolerant sorghum crop to the ACCase herbicide by at least 15%, or by at least 25%, or by at least 40%, or by at least 70%, compared to the tolerance of the same sorghum crop to which isoxadifen, esters or salts thereof was not applied.

In some embodiments, isoxadifen, esters or salts thereof is effective for reducing ACCase herbicide effects in the ACCase tolerant sorghum crop by at least 10% compared to the herbicide effects in the same sorghum crop to which isoxadifen, esters or salts thereof was not applied. In some embodiments, isoxadifen, esters or salts thereof is effective for reducing ACCase herbicide effects in the ACCase tolerant sorghum crop by at least 15% compared to the herbicide effects in the same sorghum crop to which isoxadifen, esters or salts thereof was not applied. In some embodiments, isoxadifen, esters or salts thereof is effective for reducing ACCase herbicide effects in the ACCase tolerant sorghum crop by at least 20% compared to the herbicide effects in the same sorghum crop to which isoxadifen, esters or salts thereof was not applied. In some embodiments, isoxadifen, esters or salts thereof is effective for reducing ACCase herbicide effects in the ACCase tolerant sorghum crop by at least 70% compared to the herbicide effects in the same sorghum crop to which isoxadifen, esters or salts thereof was not applied.

The methods of the present invention can be put into practice by use of an herbicidal composition comprising a) an effective amount of an ACCase inhibiting herbicide; and b) isoxadifen, esters, and salts thereof; and c) at least one agriculturally acceptable carrier.

In some embodiments, the amount of the ACCase herbicide and isoxadifen, esters or salts thereof in the composition is about 0.1-99 wt. % based on the total weight of the composition. In some embodiments, the amount of the ACCase herbicide and isoxadifen, esters or salts thereof in the composition is about 0.1-25 wt. % based on the total weight of the composition. In some embodiments, the amount of the ACCase herbicide and isoxadifen, esters or salts thereof in the composition is about 25-50 wt. % based on the total weight of the composition. In some embodiments, the amount of the ACCase herbicide and isoxadifen, esters or salts thereof in the composition is about 50-75 wt. % based on the total weight of the composition. In some embodiments, the amount of the ACCase herbicide and isoxadifen, esters or salts thereof in the composition is about 75-99 wt. % based on the total weight of the composition.

In some embodiments, the agriculturally acceptable carrier is selected from surfactants, solid carriers, liquid carriers and combinations thereof.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Examples of suitable liquid carriers useful in the present compositions include, but are not limited to, water; aromatic hydrocarbons such as alkylbenzenes and alkylnaphthalenes; alcohols such as methanol, cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers useful in the present compositions include, but are not limited to, mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

In some embodiments, the herbicidal composition further comprises at least one additional component selected from the group of wetting agents, anti-foaming agents, adhesives, neutralizers, thickeners, binders, sequestrates, fertilizers, and anti-freeze agents.

The herbicidal compositions used in the methods of the invention can be made at the time of use or diluted at the time of use. The present compositions can also be ready-to-use compositions.

The herbicidal compositions used in the methods of the invention may be employed or prepared in any conventional form, for example, in the form of a twin pack, or for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

The compositions used in the methods of the invention may also be formulated as seed treatment compositions. For seed treatment, the compositions may be formulated in the form of powder for dry seed treatment (DS), gel for seed treatment (GF), water dispersible powder for slurry seed treatment (WS), water soluble powder for seed treatment (SS), solution for seed treatment (LS), emulsion for seed treatment (ES), suspension concentrate (SC), flowable concentrate for seed treatment (FS), capsule suspension (CS), seed coated with a pesticide (PS).

Preferably, the compositions for seed treatment are formulated in the form of emulsions for seed treatment (ES), suspension concentrates (SC), flowable concentrate for seed treatment (FS) and capsule suspension (CS). Such compositions can be formulated using agriculturally acceptable carriers, surfactants or other application-promoting adjuvants customarily employed in formulation technology and formulation techniques that are known in the art.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, thickener, dispersant or emulsifier. Alternatively, it is also possible to prepare concentrates comprising active ingredient, wetting agent, thickener, dispersant or emulsifier and, if desired, solvent or oil, which are suitable for dilution with water.

A seed dressing composition may be applied to the seeds by formulating a safener and a diluent in suitable seed dressing composition form (as discussed hereinabove). Seed dressing compositions may contain the single active ingredients or the combination of active ingredients in for example encapsulated form. In some embodiments, a tank-mix composition for seed treatment application may comprise 1-85 wt. % of the herbicide and isoxadifen, esters or salts thereof based on the total weight of the composition, with the remainder of the composition comprising solid or liquid auxiliaries (including, for example, solvents, surfactants, etc.). A typical pre-mix composition for seed treatment application may comprise 0.5-99.9 wt. % of the herbicide and isoxadifen, esters or salts thereof based on the total weight of the composition, with the remainder of the composition comprising solid or liquid auxiliaries (including, for example, solvents, surfactants, etc.).

In some embodiments, the herbicidal mixture is applied at a rate from 1 g/ha to 600 g/ha. In some embodiments, the herbicidal mixture is applied at a rate from 1 g/ha to 500 g/ha. In some embodiments, the herbicidal mixture is applied at a rate from 1 g/ha to 300 g/ha. In some embodiments, the herbicidal mixture is applied at a rate from 80 g/ha to 300 g/ha. In some embodiments, the herbicidal mixture is applied at a rate of 125 g/ha. In some embodiments, the herbicidal mixture is applied at a rate from 350 g/ha to 500 g/ha.

In some embodiments, the herbicidal mixture is applied at a rate from 0.1 liter/ha to 300 liter/ha. In some embodiments, the herbicidal mixture is applied at a rate from 100 liter/ha to 300 liter/ha. In some embodiments, the herbicidal mixture is applied at a rate of about 200 liter/ha. In some embodiments, the herbicidal mixture is applied at a rate from 0.1 liter/ha to 10 liter/ha. In some embodiments, the herbicidal mixture is applied at a rate from 0.2 liter/ha to 5 liter/ha. In some embodiments, the herbicidal mixture is applied at a rate of 1.25 liter/ha.

In some embodiments, the herbicidal mixture may be applied to seeds of the sorghum crop as seed treatment before planting. In some embodiments, the herbicidal mixture applied to the seeds at a rate from 0.1 g/100 kg of seeds to 1000 g/100 kg of seeds. In some embodiments, the herbicidal mixture is applied to the seeds at a rate from 1 g/100 kg of seeds to 750 g/100 kg of seeds. In a further embodiment, the herbicidal mixture is applied to the seeds at a rate from 30 g/100 kg of seeds to 300 g/100 kg of seeds.

In some embodiments, the method comprises applying two or more safeners to the ACCase tolerant sorghum crop or the seeds thereof. In some embodiment, the method comprises treating the ACCase tolerant sorghum crop or the seeds thereof with a mixture of two or more safeners.

In some embodiments, the ACCase herbicide and/or safener is applied to the ACCase tolerant sorghum crop, the locus of the ACCase tolerant sorghum crop and/or the propagation material of the ACCase tolerant sorghum crop.

In some embodiments, the ACCase herbicide and/or isoxadifen, esters or salts thereof is applied to the locus of undesired vegetation pre-emergence. In some embodiments, the ACCase herbicide and/or isoxadifen, esters or salts thereof is applied to the locus of undesired vegetation post emergence.

The application rates of the combination may vary, depending on the desired effect.

In some embodiments, the ACCase herbicide is applied at a rate that would inhibit growth of the ACCase tolerant sorghum crop if the ACCase herbicide was applied without isoxadifen, esters or salts thereof.

In some embodiments, the ACCase herbicide is applied at a rate from about 1 g/ha to about 250 g/ha. In some embodiments, the ACCase herbicide is applied at a rate from about 1 g/ha to about 200 g/ha. In some embodiments, the ACCase herbicide is applied at a rate from about 1 g/ha to about 150 g/ha. In some embodiments, the ACCase herbicide is applied at a rate from about 1 g/ha to about 75 g/ha. In some embodiments, the ACCase herbicide is applied at a rate from about 1 g/ha to about 20 g/ha. In some embodiments, the ACCase herbicide is applied at a rate from about 1 g/ha to about 10 g/ha.

In some embodiments, the ACCase herbicide is applied at a rate of 2 g/ha. In some embodiments, the ACCase herbicide is applied at a rate of 6 g/ha. In some embodiments, the ACCase herbicide is applied at a rate of 18 g/ha. In some embodiments, the ACCase herbicide is applied at a rate of 54 g/ha. In some embodiments, the ACCase herbicide is applied at a rate of 162 g/ha.

In some embodiments, the ACCase herbicide is applied at a rate of 2.2 g/ha. In some embodiments, the ACCase herbicide is applied at a rate of 6.6 g/ha. In some embodiments, the ACCase herbicide is applied at a rate of 19.7 g/ha. In some embodiments, the ACCase herbicide is applied at a rate of 54.9 g/ha. In some embodiments, the ACCase herbicide is applied at a rate of 177.3 g/ha.

In some embodiments, the ACCase herbicide is applied at a rate from about 25 g/ha to about 250 g/ha. In some embodiments, the ACCase herbicide is applied at a rate from about 25 g/ha to about 50 g/ha. In some embodiments, the ACCase herbicide is applied at a rate from about 50 g/ha to about 250 g/ha. In some embodiments, the ACCase herbicide is applied at a rate from about 50 g/ha to about 100 g/ha. In some embodiments, the ACCase herbicide is applied at a rate from about 100 g/ha to about 200 g/ha. In some embodiments, the ACCase herbicide is applied at a rate from about 200 g/ha to about 250 g/ha. In some embodiments, the ACCase herbicide is applied at a rate from about 30 g/ha to about 70 g/ha. In some embodiments, the ACCase herbicide is applied at a rate of about 5 g/ha. In some embodiments, the ACCase herbicide is applied at a rate of about 10 g/ha. In some embodiments, the ACCase herbicide is applied at a rate of about 15 g/ha. In some embodiments, the herbicide is applied at a rate of about 20 g/ha. In some embodiments, the ACCase herbicide is applied at a rate of about 30 g/ha. In some embodiments, the ACCase herbicide is applied at a rate of about 40 g/ha. In some embodiments, the ACCase herbicide is applied at a rate of about 50 g/ha. In some embodiments, the ACCase herbicide is applied at a rate of about 60 g/ha. In some embodiments, the ACCase herbicide is applied at a rate of about 70 g/ha.

In some embodiments, isoxadifen, esters or salts thereof is applied a rate from about 1 g/ha to about 150 g/ha. In some embodiments, isoxadifen, esters or salts thereof is applied a rate from about 1 g/ha to about 100 g/ha. In some embodiments, isoxadifen, esters or salts thereof is applied at a rate from about 5 g/ha to about 50 g/ha. In some embodiments, isoxadifen, esters or salts thereof is applied a rate from about 1 g/ha to about 12.5 g/ha. In some embodiments, isoxadifen, esters or salts thereof is applied at a rate from about 12.5 g/ha to about 25 g/ha. In some embodiments, isoxadifen, esters or salts thereof is applied a rate from about 25 g/ha to about 50 g/ha. In some embodiments, isoxadifen, esters or salts thereof is applied at a rate from about 50 g/ha to about 100 g/ha. In some embodiments, isoxadifen, esters or salts thereof is applied at a rate from about 100 g/ha to about 150 g/ha. In some embodiments, isoxadifen, esters or salts thereof is applied a rate from about 12.5 g/ha to about 100 g/ha. In some embodiments, isoxadifen, esters or salts thereof is applied a rate of about 12.5 g/ha. In some embodiments, isoxadifen, esters or salts thereof is applied a rate of about 25 g/ha. In some embodiments, isoxadifen, esters or salts thereof is applied a rate of about 50 g/ha. In some embodiments, isoxadifen, esters or salts thereof is applied a rate of 100 g/ha.

In some embodiments, isoxadifen, esters or salts thereof is applied to seeds of the ACCase tolerant sorghum crop. In some embodiments, isoxadifen, esters or salts thereof is applied at a rate of 0.1 g to 5 g of safener per kg of seeds. In some embodiments, isoxadifen, esters or salts thereof is applied at a rate of 0.5 g to 2 g of safener per kg of seeds. In some embodiments, isoxadifen, esters or salts thereof is applied at a rate of 0.5 g to 1 g of safener per kg of seeds. In some embodiments, isoxadifen, esters or salts thereof is applied at a rate of 1 g to 2 g of safener per kg of seeds. In some embodiments, isoxadifen, esters or salts thereof is applied at a rate of 0.5 g of safener per kg of seeds. In some embodiments, isoxadifen, esters or salts thereof is applied at a rate of 1 g of safener per kg of seeds. In some embodiments, isoxadifen, esters or salts thereof is applied at a rate of 2 g of safener per kg of seeds.

In some embodiments, the ACCase herbicide and isoxadifen, esters or salts thereof are applied simultaneously, separately, or sequentially. In some embodiments, the ACCase herbicide and isoxadifen, esters or salts thereof are applied simultaneously in a tank mix.

In some embodiments, the weight ratio if isoxadifen, esters or salts thereof to the ACCase herbicide in the tank mix is from about 1:1 to about 1:5.

In some embodiments, the ACCase herbicide is applied one to three times during the growing season.

In some embodiments, the ACCase herbicide and isoxadifen, esters or salts thereof are prepared as separate formulations, and the individual formulations are applied as is, or diluted to predetermined concentrations. In other embodiments, the ACCase herbicide and isoxadifen, esters or salts thereof are prepared as separate formulations, and the formulations are mixed when diluted to a predetermined concentration. In other embodiments, the ACCase herbicide and isoxadifen, esters or salts thereof are prepared as separate formulations, and the formulations are mixed as tank mix before or after dilution to a predetermined concentration. In other embodiments, the ACCase herbicide and isoxadifen, esters or salts thereof are formulated together, and the formulation is applied as it is, or the formulation is diluted to a predetermined concentration.

In some embodiments, the ACCase herbicide and/or isoxadifen, esters or salts thereof are applied via foliar application, basal application, soil application, soil incorporation, soil injection or seed treatment.

In some embodiments, isoxadifen, esters or salts thereof is applied 7 days, 6 days, 5 days, 4 days, 3 days, 2 days, or 1 day before the ACCase herbicide application.

In some embodiments, isoxadifen, esters or salts thereof is applied 1 day, 2 days, 3 days, or 4 days after the ACCase herbicide application.

In some embodiments, isoxadifen, esters or salts thereof is applied parallel to application of the ACCase herbicide.

In some embodiments, isoxadifen, esters or salts thereof and ACCase herbicide are applied on the same day.

In some of the embodiments, the metabolism rate of the ACCase herbicide in the ACCase tolerant sorghum crop is more than 3 days, 5 days, 10 days, 20 days, 30 days, or 50 days.

The present invention also provides a method for reducing herbicide effects of an ACCase inhibiting herbicides in ACCase tolerant sorghum crop, comprising applying isoxadifen, esters or salts thereof to a plant and/or seed of the ACCase tolerant sorghum crop so as to thereby reduce herbicide effects in the ACCase tolerant sorghum crop compared to the herbicide effects in the same sorghum crop to which isoxadifen, esters or salts thereof was not applied.

In some embodiments, isoxadifen, esters or salts thereof is applied to the ACCase tolerant sorghum crop 7 days, 6 days, 5 days, 4 days, 3 days, 2 days, or 1 day before the ACCase herbicide application.

In some embodiments, isoxadifen, esters or salts thereof is applied to the ACCase tolerant sorghum crop 1 day, 2 days, 3 days, or 4 days after the ACCase herbicide application.

In some embodiments, isoxadifen, esters or salts thereof is applied to the ACCase tolerant sorghum crop parallel to application of the ACCase herbicide.

In some embodiments, isoxadifen, esters or salts thereof and ACCase herbicide are applied to the ACCase tolerant sorghum crop on the same day.

The present invention also provides a method for increasing tolerance to an ACCase inhibiting herbicide in an ACCase tolerant sorghum crop wherein the ACCase tolerant sorghum crop is treated with isoxadifen, esters or salts thereof.

Preferably, the herbicidal composition used in the methods of the invention comprises (i) a mixture quizalofop and isoxadifen, esters or salts thereof, and (ii) at least one agriculturally acceptable carrier.

Each embodiment disclosed herein is contemplated as being applicable to each of the other disclosed embodiments. Thus, all combinations of the various elements described herein are within the scope of the invention. In addition, the elements recited in mixture embodiments can be used in the composition, methods, use, kit and sorghum crop embodiments described herein and vice versa.

Examples are provided below to facilitate a more complete understanding of the present subject matter. The following examples illustrate the exemplary modes of making and practicing the present subject matter. However, the scope of the present subject matter is not limited to specific embodiments disclosed in these Examples, which are for purposes of illustration only. Other embodiments will be apparent to one skilled in the art from consideration of the specification and examples. It is intended that the specification, including the examples, is considered exemplary only without limiting the scope and spirit of the present subject matter.

All publications, patents and patent applications mentioned in this specification are herein incorporated in their entirety by reference into the specification, to the same extent as if each individual publication, patent or patent application was specifically and individually indicated to be incorporated herein by reference.

The following examples illustrate the practice of the present subject matter in some of its embodiments, should not be construed as limiting the scope of the present subject matter. Other embodiments will be apparent to one skilled in the art from consideration of the specification and examples. It is intended that the specification, including the examples, is considered exemplary only, without limiting the scope and spirit of the present subject matter.

### EXPERIMENTAL DETAILS

### Example 1: Effect of Quizalofop and Safeners on ACCase Tolerant Sorghum

Tolerant Sorghum

Seeds of the proprietary ACCase tolerant sorghum variety BTX430-CHR-ACC1 (ATCC deposit PTA-125106, mutation W1999C) were supplied by S&W. BTX430-CHR-ACC1 sorghum cultivar contains a single mutation in the ACCase gene that confers ACCase tolerance: Tryptophan to Cysteine amino acid substitution at an amino acid position 1999 (W1999C; SEQ ID NO: 7 as disclosed in WO 2018/222715, namely the sequence denoted herein by SEQ ID NO: 6) aligning with the amino acid sequence of SEQ ID NO: 6 (as disclosed in WO 2018/222715, namely the sequence denoted herein by SEQ ID NO: 5). The mutation provides tolerance to quizalofop.

Growing Conditions, Materials and Methods

ACCase tolerant Sorghum seeds (S & W Line ID: T19-90001) were planted in commercial greenhouse soil mix in ˜8-cm square pots.

Plants were started in a greenhouse and placed outdoors at ambient air temperatures when temperatures were conducive to sorghum growth.

Soil fertility and moisture were provided on an as needed basis.

Plants were grown to heights of 10 to 13, 15-18, 20 to 25 and 30 to 35 cm for treatment.

Herbicide and Safener Application

Generally, plants were treated as shown below with formulated quizalofop P-ethyl or ADM.7000.H.2.A (quizalofop+isoxadifen, manufactured by ADAMA) through a moving nozzle spray system in a spray volume of 235 I/ha. Safener was premixed in the ADM.7000.H.2.A formulation. Herbicides were applied with 1% v/v Crop Oil Concentrate, in accordance with standard recommended applications of quizalofop.

Method of Evaluating Plant Damage to the ACCase Herbicide and Level of Tolerance

Sorghum plants were subjected to “Standard Weed Science Percentage Rankings” where 0=no effect of the herbicide and 100%=complete plant death. Injury represents discoloration, stunting and malformation. Ratings were taken approximately 14 days after herbicide application. In each case the amounts of Quizalofop and of Isoxadifen are indicated in Table 2 below.

TABLE 2

| X-rate used in green house experiment | | |
|---|---|---|
| | Quizalofop | Isoxadifen |
| X-Rate | g/ha | |
| 0.5 | 39 | 27 |
| 1 | 77 | 54 |
| 2 | 155 | 108 |
| 4 | 308 | 216 |
| 8 | 616 | 431 |

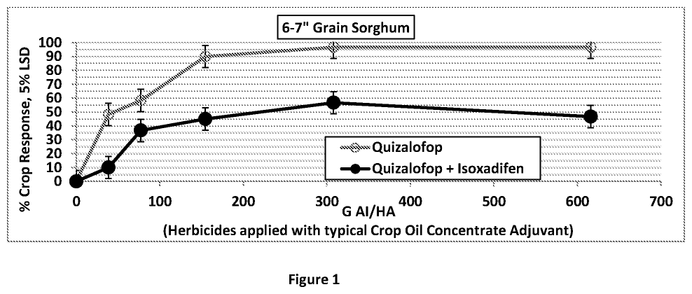

The results are shown in FIG. 1, charting the crop response (i.e. the percentage of sorghum crop displaying phytotoxicity) against the X-Rate. FIG. 1 clearly shows a significant decrease of crop response when isoxadifen is used.

Further field trials were performed to confirm the above results and to test the whether the mixture of Quizalofop and Isoxadifen maintained an excellent control of different weeds.

The effect over sorghum plants infested with shattercane (Sorghum bicolor) was checked using different amounts of Quizalofop and of Isoxadifen. Table 3 shows the results after 7 days.

TABLE 3

| | Quizalofop | Isoxadifen | % | % control |
|---|---|---|---|---|
| X-rate | (oz/a) | (oz/a) | phytotoxicity | Shattercane |
| 0.5 | 5 | — | 12.5 | 96.8 |
| 0.5 | 5 | 5 | 1.3 | 96.8 |
| 1 | 10 | — | 40 | 96.8 |
| 1 | 10 | 10 | 3.8 | 96.8 |
| 2 | 20 | — | 65 | 99 |
| 2 | 20 | 20 | 13.8 | 99 |

The effect over sorghum plants infested with Setaria viridis and Panicum miliace was checked using different amounts of Quizalofop and of Isoxadifen. Table 4 shows the results after 33 days.

TABLE 4

| | | | | % control | % control |
|---|---|---|---|---|---|
| | Quizalofop | Isoxadifen | % | Setaria | Panicum |
| X-rate | (oz/a) | (oz/a) | phytotoxicity | viridis | miliace |
| 0.5 | 5 | — | 5 | 100 | 100 |
| 0.5 | 5 | 5 | 0 | 100 | 100 |
| 1 | 10 | — | 16.7 | 100 | 100 |
| 1 | 10 | 10 | 0 | 100 | 100 |
| 2 | 20 | — | 56.7 | 100 | 100 |
| 2 | 20 | 20 | 16.7 | 100 | 100 |

On a second trial the effect over sorghum plants infested with Setaria viridis was checked using different amounts of Quizalofop and of Isoxadifen. Table 5 shows the results after 27 days.

TABLE 5

| | | | | % control | % control |
|---|---|---|---|---|---|
| | Quizalofop | Isoxadifen | % | Setaria | Panicum |
| X-rate | (oz/a) | (oz/a) | phytotoxicity | viridis | miliace |
| 0.5 | 5 | — | 2.5 | 100 | 100 |
| 0.5 | 5 | 5 | 0 | 100 | 100 |
| 1 | 10 | — | 15 | 100 | 100 |
| 1 | 10 | 10 | 0 | 100 | 100 |
| 2 | 20 | — | 52.5 | 100 | 100 |
| 2 | 20 | 20 | 15 | 100 | 100 |

In all cases the phytotoxicity was significantly reduced, and in all cases at regular application levels of Quizalofop no phytotoxicity was observed. These results are surprising, specially taking into account that at the same time the control of the weeds was maintained; in some cases even slightly increased (see X-1 and X-2 results in Table 3).

1. A method of controlling undesired vegetation in the vicinity of an ACCase tolerant sorghum crop comprising applying a) an effective amount of an ACCase inhibiting herbicide; and b) an effective amount of isoxadifen, esters, or salts thereof to a locus of the undesired vegetation so as to effectively control the undesired vegetation.

2. The method of claim 1, wherein the ACCase inhibiting herbicide is prop aquizafop or quizalofop.

3. The method of claim 1, wherein isoxadifen, esters or salts thereof is isoxadifen-dietheyl.

4. The method of claim 1, wherein:
a. the method comprises applying a mixture of one, two or more safeners,
b. isoxadifen, esters or salts thereof and/or the herbicide is applied to the sorghum crop, the locus of the sorghum crop and/or the propagation material of the sorghum crop,
c. isoxadifen, esters or salts thereof and/or the herbicide is applied pre-emergence,
d. isoxadifen, esters or salts thereof and/or the herbicide is applied post-emergence,
e. the herbicide is applied at a rate from 1 g/ha to 250 g/ha,
f. isoxadifen, esters or salts thereof is applied at rate from 1 g/ha to 150 g/ha, or
g. isoxadifen, esters or salts thereof is applied to seeds of the ACCase tolerant sorghum crop at a rate from 0.1 g to 5 g of safener per kg of seeds.

5. The method of claim 1, wherein the herbicide is applied at a rate from 1 g/ha to 700 g/ha and/or isoxadifen, esters or salts thereof is applied at a rate of 0.7 to 490 g/ha.

6. The method of claim 1, wherein the herbicide and isoxadifen, esters or salts thereof are applied simultaneously, separately, or sequentially.

7. The method of claim 1, wherein the undesired vegetation is monocot, dicot or sedge.

8. The method of claim 1, wherein the undesired vegetation including escaped annual grasses (sandbur (Chenchrus spp.), in particular), shattercane (Sorghum bicolor) and Johnsongrass (Sorghum halepense).

9.-12. (canceled)

13. An ACCase tolerant sorghum crop with increased tolerance to an ACCase inhibiting herbicide obtainable by treating the sorghum crop with isoxadifen, esters or salts thereof.

14. A method of controlling undesired vegetation in the vicinity of an ACCase tolerant sorghum crop comprising (i) applying isoxadifen, esters or salts thereof to a seed of the ACCase tolerant sorghum crop and (ii) applying an effective amount of an ACCase inhibiting herbicide to a locus of the undesired vegetation so as to effectively control the undesired vegetation.


SEQUENCE LISTING (9 sequences)

SEQ ID NO: 1 - DNA, 1863 bp, Artificial Sequence
  Synthetic Polynucleotide
  misc_feature: ACC1 (TGG to TGC)
gcaaactctggtgctaggattggcatagctgatgaagtaaaatcttgcttccgtgttgggtggtctgacgaaggcagccctgagcgagggtttcagtacatctatctgactgaagaagactatgcccgtattagctcttctgttatagcacataagctgcagctagatagcggtgaaattaggtggattattgactctgttgtgggcaaggaggatgggcttggtgttgagaacatacatggaagtgctgctatcgccagtgcttattctagggcatatgaggagacatttacacttacatttgtgaccggacggactgtaggaataggagcttatcttgctagacttggtatacggtgcatacagcgtcttgaccagccaattattttaacagggttttctgccctgaacaagctccttgggcgggaagtgtacagctcccacatgcagcttggtggtcctaagatcatggcgaccaatggtgttgtccacctgactgttccagatgaccttgaaggtgtttccaatatattgaggtggctcagctatgttcctgcaaacattggtggacctcttcctattaccaaacctttggaccctccagacagacctgttgcatacatccctgagaacacatgcgatccacgtgcagccatccgtggtgtagatgacagccaagggaaatggttgggtggtatgtttgacaaagacagctttgtggagacatttgaaggatgggcaaaaacagtggttactggcagagcaaagcttggaggaattcctgtgggtgtcatagctgtggagacacagaccatgatgcagcttgtccctgctgatccaggtcagcttgattcccatgagcgatccgttcctcgggctggacaagtgtgcttcccagattctgcaaccaagacagctcaggcattattagacttcaaccgtgaaggattgcctctgtttatcctggctaactggagaggtttctctggtggacagagagatctctttgaaggaattcttcaggctgggtcaacaattgtcgagaaccttaggacatataatcagcctgcgtttgtctacattcctatggctggagagcttcgtggaggagcttgggttgtggtcgatagcaaaataaatccagaccgcattgagtgttatgctgagaggactgccaaaggtaatgttctcgaacctcaagggttaattgaaatcaagttcaggtcagaggaactccaagactgtatgggtaggcttgaccccgagttgataaatctgaaagcaaaactccaagatgtaaagcatggaaatggaagtctaccagacatagaatcccttcagaagagtatagaagcacgtacgaaacagttgctgcctttatatacccagattgcaatacggtttgctgaattgcatgatacttccctaagaatggcagctaaaggcgtgattaagaaagttgtagactgggaagaatcacgctctttcttctataaaaggctacggagaaggatctctgaagatgttcttgcaaaagaaataagacatatagtcggtgacaacttcactcaccaatcagcaatggagctcatcaaggaatggtacctggcttctccagccacagcaggaagcactggatgggatgacgatgatgcatttgttgcctggaaggacagtcctgaaaactacaatggatatatccaagagctaagggctcaaaaagtgtctcagtcgctctctgatctcactgactccagttcagatctacaagcattctcgcagggtctttctacgctattagataagatggatccctctcaaagagcgaagtttgttcaggaagtcaagaaggtccttggttga

SEQ ID NO: 2 - DNA, 1863 bp, Artificial Sequence
  Synthetic Polynucleotide
  misc_feature: ACC2 (TGG to TCG)
gcaaactctggtgctaggattggcatagctgatgaagtaaaatcttgcttccgtgttgggtggtctgacgaaggcagccctgagcgagggtttcagtacatctatctgactgaagaagactatgcccgtattagctcttctgttatagcacataagctgcagctagatagcggtgaaattaggtggattattgactctgttgtgggcaaggaggatgggcttggtgttgagaacatacatggaagtgctgctatcgccagtgcttattctagggcatatgaggagacatttacacttacatttgtgaccggacggactgtaggaataggagcttatcttgctagacttggtatacggtgcatacagcgtcttgaccagccaattattttaacagggttttctgccctgaacaagctccttgggcgggaagtgtacagctcccacatgcagcttggtggtcctaagatcatggcgaccaatggtgttgtccacctgactgttccagatgaccttgaaggtgtttccaatatattgaggtggctcagctatgttcctgcaaacattggtggacctcttcctattaccaaacctttggaccctccagacagacctgttgcatacatccctgagaacacatgcgatccacgtgcagccatccgtggtgtagatgacagccaagggaaatggttgggtggtatgtttgacaaagacagctttgtggagacatttgaaggatgggcaaaaacagtggttactggcagagcaaagcttggaggaattcctgtgggtgtcatagctgtggagacacagaccatgatgcagcttgtccctgctgatccaggtcagcttgattcccatgagcgatccgttcctcgggctggacaagtgtcgttcccagattctgcaaccaagacagctcaggcattattagacttcaaccgtgaaggattgcctctgtttatcctggctaactggagaggtttctctggtggacagagagatctctttgaaggaattcttcaggctgggtcaacaattgtcgagaaccttaggacatataatcagcctgcgtttgtctacattcctatggctggagagcttcgtggaggagcttgggttgtggtcgatagcaaaataaatccagaccgcattgagtgttatgctgagaggactgccaaaggtaatgttctcgaacctcaagggttaattgaaatcaagttcaggtcagaggaactccaagactgtatgggtaggcttgaccccgagttgataaatctgaaagcaaaactccaagatgtaaagcatggaaatggaagtctaccagacatagaatcccttcagaagagtatagaagcacgtacgaaacagttgctgcctttatatacccagattgcaatacggtttgctgaattgcatgatacttccctaagaatggcagctaaaggcgtgattaagaaagttgtagactgggaagaatcacgctctttcttctataaaaggctacggagaaggatctctgaagatgttcttgcaaaagaaataagacatatagtcggtgacaacttcactcaccaatcagcaatggagctcatcaaggaatggtacctggcttctccagccacagcaggaagcactggatgggatgacgatgatgcatttgttgcctggaaggacagtcctgaaaactacaatggatatatccaagagctaagggctcaaaaagtgtctcagtcgctctctgatctcactgactccagttcagatctacaagcattctcgcagggtctttctacgctattagataagatggatccctctcaaagagcgaagtttgttcaggaagtcaagaaggtccttggttga

SEQ ID NO: 3 - DNA, 1863 bp, Artificial Sequence
  Synthetic Polynucleotide
  misc_feature: ACC3 (GCA to GTA)
gcaaactctggtgctaggattggcatagctgatgaagtaaaatcttgcttccgtgttgggtggtctgacgaaggcagccctgagcgagggtttcagtacatctatctgactgaagaagactatgcccgtattagctcttctgttatagcacataagctgcagctagatagcggtgaaattaggtggattattgactctgttgtgggcaaggaggatgggcttggtgttgagaacatacatggaagtgctgctatcgccagtgcttattctagggcatatgaggagacatttacacttacatttgtgaccggacggactgtaggaataggagcttatcttgctagacttggtatacggtgcatacagcgtcttgaccagccaattattttaacagggttttctgccctgaacaagctccttgggcgggaagtgtacagctcccacatgcagcttggtggtcctaagatcatggcgaccaatggtgttgtccacctgactgttccagatgaccttgaaggtgtttccaatatattgaggtggctcagctatgttcctgcaaacattggtggacctcttcctattaccaaacctttggaccctccagacagacctgttgcatacatccctgagaacacatgcgatccacgtgcagccatccgtggtgtagatgacagccaagggaaatggttgggtggtatgtttgacaaagacagctttgtggagacatttgaaggatgggcaaaaacagtggttactggcagagcaaagcttggaggaattcctgtgggtgtcatagctgtggagacacagaccatgatgcagcttgtccctgctgatccaggtcagcttgattcccatgagcgatccgttcctcgggctggacaagtgtcgttcccagattctgtaaccaagacagctcaggcattattagacttcaaccgtgaaggattgcctctgtttatcctggctaactggagaggtttctctggtggacagagagatctctttgaaggaattcttcaggctgggtcaacaattgtcgagaaccttaggacatataatcagcctgcgtttgtctacattcctatggctggagagcttcgtggaggagcttgggttgtggtcgatagcaaaataaatccagaccgcattgagtgttatgctgagaggactgccaaaggtaatgttctcgaacctcaagggttaattgaaatcaagttcaggtcagaggaactccaagactgtatgggtaggcttgaccccgagttgataaatctgaaagcaaaactccaagatgtaaagcatggaaatggaagtctaccagacatagaatcccttcagaagagtatagaagcacgtacgaaacagttgctgcctttatatacccagattgcaatacggtttgctgaattgcatgatacttccctaagaatggcagctaaaggcgtgattaagaaagttgtagactgggaagaatcacgctctttcttctataaaaggctacggagaaggatctctgaagatgttcttgcaaaagaaataagacatatagtcggtgacaacttcactcaccaatcagcaatggagctcatcaaggaatggtacctggcttctccagccacagcaggaagcactggatgggatgacgatgatgcatttgttgcctggaaggacagtcctgaaaactacaatggatatatccaagagctaagggctcaaaaagtgtctcagtcgctctctgatctcactgactccagttcagatctacaagcattctcgcagggtctttctacgctattagataagatggatccctctcaaagagcgaagtttgttcaggaagtcaagaaggtccttggttga

SEQ ID NO: 4 - DNA, 1863 bp, Artificial Sequence
  Synthetic Polynucleotide
  misc_feature: ACC4 (TGG to TCG)
gcaaactctggtgctaggattggcatagctgatgaagtaaaatcttgcttccgtgttgggtggtctgacgaaggcagccctgagcgagggtttcagtacatctatctgactgaagaagactatgcccgtattagctcttctgttatagcacataagctgcagctagatagcggtgaaattaggtggattattgactctgttgtgggcaaggaggatgggcttggtgttgagaacatacatggaagtgctgctatcgccagtgcttattctagggcatatgaggagacatttacacttacatttgtgaccggacggactgtaggaataggagcttatcttgctagacttggtatacggtgcatacagcgtcttgaccagccaattattttaacagggttttctgccctgaacaagctccttgggcgggaagtgtacagctcccacatgcagcttggtggtcctaagatcatggcgaccaatggtgttgtccacctgactgttccagatgaccttgaaggtgtttccaatatattgaggtggctcagctatgttcctgcaaacattggtggacctcttcctattaccaaacctttggaccctccagacagacctgttgcatacatccctgagaacacatgcgatccacgtgcagccatccgtggtgtagatgacagccaagggaaatggttgggtggtatgtttgacaaagacagctttgtggagacatttgaaggatgggcaaaaacagtggttactggcagagcaaagcttggaggaattcctgtgggtgtcatagctgtggagacacagaccatgatgcagcttgtccctgctgatccaggtcagcttgattcccatgagcgatccgttcctcgggctggacaagtgtcgttcccagattctgtaaccaagacagctcaggcattattagacttcaaccgtgaaggattgcctctgtttatcctggctaactcgagaggtttctctggtggacagagagatctctttgaaggaattcttcaggctgggtcaacaattgtcgagaaccttaggacatataatcagcctgcgtttgtctacattcctatggctggagagcttcgtggaggagcttgggttgtggtcgatagcaaaataaatccagaccgcattgagtgttatgctgagaggactgccaaaggtaatgttctcgaacctcaagggttaattgaaatcaagttcaggtcagaggaactccaagactgtatgggtaggcttgaccccgagttgataaatctgaaagcaaaactccaagatgtaaagcatggaaatggaagtctaccagacatagaatcccttcagaagagtatagaagcacgtacgaaacagttgctgcctttatatacccagattgcaatacggtttgctgaattgcatgatacttccctaagaatggcagctaaaggcgtgattaagaaagttgtagactgggaagaatcacgctctttcttctataaaaggctacggagaaggatctctgaagatgttcttgcaaaagaaataagacatatagtcggtgacaacttcactcaccaatcagcaatggagctcatcaaggaatggtacctggcttctccagccacagcaggaagcactggatgggatgacgatgatgcatttgttgcctggaaggacagtcctgaaaactacaatggatatatccaagagctaagggctcaaaaagtgtctcagtcgctctctgatctcactgactccagttcagatctacaagcattctcgcagggtctttctacgctattagataagatggatccctctcaaagagcgaagtttgttcaggaagtcaagaaggtccttggttga

SEQ ID NO: 5 - protein, 620 aa, Sorghum
  MISC_FEATURE: Sorghum Wild type CT domain sequence
ANSGARIGIADEVKSCFRVGWSDEGSPERGFQYIYLTEEDYARISSSVIAHKLQLDSGEIRWIIDSVVGKEDGLGVENIHGSAAIASAYSRAYEETFTLTFVTGRTVGIGAYLARLGIRCIQRLDQPIILTGFSALNKLLGREVYSSHMQLGGPKIMATNGVVHLTVPDDLEGVSNILRWLSYVPANIGGPLPITKPLDPPDRPVAYIPENTCDPRAAIRGVDDSQGKWLGGMFDKDSFVETFEGWAKTVVTGRAKLGGIPVGVIAVETQTMMQLVPADPGQLDSHERSVPRAGQVWFPDSATKTAQALLDFNREGLPLFILANWRGFSGGQRDLFEGILQAGSTIVENLRTYNQPAFVYIPMAGELRGGAWVVVDSKINPDRIECYAERTAKGNVLEPQGLIEIKFRSEELQDCMGRLDPELINLKAKLQDVKHGNGSLPDIESLQKSIEARTKQLLPLYTQIAIRFAELHDTSLRMAAKGVIKKVVDWEESRSFFYKRLRRRISEDVLAKEIRHIVGDNFTHQSAMELIKEWYLASPATAGSTGWDDDDAFVAWKDSPENYNGYIQELRAQKVSQSLSDLTDSSSDLQAFSQGLSTLLDKMDPSQRAKFVQEVKKVLG

SEQ ID NO: 6 - protein, 620 aa, Artificial Sequence
  Synthetic Polypeptide
  MISC_FEATURE: ACC1 (W1999C)
ANSGARIGIADEVKSCFRVGWSDEGSPERGFQYIYLTEEDYARISSSVIAHKLQLDSGEIRWIIDSVVGKEDGLGVENIHGSAAIASAYSRAYEETFTLTFVTGRTVGIGAYLARLGIRCIQRLDQPIILTGFSALNKLLGREVYSSHMQLGGPKIMATNGVVHLTVPDDLEGVSNILRWLSYVPANIGGPLPITKPLDPPDRPVAYIPENTCDPRAAIRGVDDSQGKWLGGMFDKDSFVETFEGWAKTVVTGRAKLGGIPVGVIAVETQTMMQLVPADPGQLDSHERSVPRAGQVCFPDSATKTAQALLDFNREGLPLFILANWRGFSGGQRDLFEGILQAGSTIVENLRTYNQPAFVYIPMAGELRGGAWVVVDSKINPDRIECYAERTAKGNVLEPQGLIEIKFRSEELQDCMGRLDPELINLKAKLQDVKHGNGSLPDIESLQKSIEARTKQLLPLYTQIAIRFAELHDTSLRMAAKGVIKKVVDWEESRSFFYKRLRRRISEDVLAKEIRHIVGDNFTHQSAMELIKEWYLASPATAGSTGWDDDDAFVAWKDSPENYNGYIQELRAQKVSQSLSDLTDSSSDLQAFSQGLSTLLDKMDPSQRAKFVQEVKKVLG

SEQ ID NO: 7 - protein, 620 aa, Artificial Sequence
  Synthetic Polypeptide
  MISC_FEATURE: ACC2 (W1999S)
ANSGARIGIADEVKSCFRVGWSDEGSPERGFQYIYLTEEDYARISSSVIAHKLQLDSGEIRWIIDSVVGKEDGLGVENIHGSAAIASAYSRAYEETFTLTFVTGRTVGIGAYLARLGIRCIQRLDQPIILTGFSALNKLLGREVYSSHMQLGGPKIMATNGVVHLTVPDDLEGVSNILRWLSYVPANIGGPLPITKPLDPPDRPVAYIPENTCDPRAAIRGVDDSQGKWLGGMFDKDSFVETFEGWAKTVVTGRAKLGGIPVGVIAVETQTMMQLVPADPGQLDSHERSVPRAGQVSFPDSATKTAQALLDFNREGLPLFILANWRGFSGGQRDLFEGILQAGSTIVENLRTYNQPAFVYIPMAGELRGGAWVVVDSKINPDRIECYAERTAKGNVLEPQGLIEIKFRSEELQDCMGRLDPELINLKAKLQDVKHGNGSLPDIESLQKSIEARTKQLLPLYTQIAIRFAELHDTSLRMAAKGVIKKVVDWEESRSFFYKRLRRRISEDVLAKEIRHIVGDNFTHQSAMELIKEWYLASPATAGSTGWDDDDAFVAWKDSPENYNGYIQELRAQKVSQSLSDLTDSSSDLQAFSQGLSTLLDKMDPSQRAKFVQEVKKVLG

SEQ ID NO: 8 - protein, 620 aa, Artificial Sequence
  Synthetic Polypeptide
  MISC_FEATURE: ACC3 (A2004V)
ANSGARIGIADEVKSCFRVGWSDEGSPERGFQYIYLTEEDYARISSSVIAHKLQLDSGEIRWIIDSVVGKEDGLGVENIHGSAAIASAYSRAYEETFTLTFVTGRTVGIGAYLARLGIRCIQRLDQPIILTGFSALNKLLGREVYSSHMQLGGPKIMATNGVVHLTVPDDLEGVSNILRWLSYVPANIGGPLPITKPLDPPDRPVAYIPENTCDPRAAIRGVDDSQGKWLGGMFDKDSFVETFEGWAKTVVTGRAKLGGIPVGVIAVETQTMMQLVPADPGQLDSHERSVPRAGQVWFPDSVTKTAQALLDFNREGLPLFILANWRGFSGGQRDLFEGILQAGSTIVENLRTYNQPAFVYIPMAGELRGGAWVVVDSKINPDRIECYAERTAKGNVLEPQGLIEIKFRSEELQDCMGRLDPELINLKAKLQDVKHGNGSLPDIESLQKSIEARTKQLLPLYTQIAIRFAELHDTSLRMAAKGVIKKVVDWEESRSFFYKRLRRRISEDVLAKEIRHIVGDNFTHQSAMELIKEWYLASPATAGSTGWDDDDAFVAWKDSPENYNGYIQELRAQKVSQSLSDLTDSSSDLQAFSQGLSTLLDKMDPSQRAKFVQEVKKVLG

SEQ ID NO: 9 - protein, 620 aa, Artificial Sequence
  Synthetic Polypeptide
  MISC_FEATURE: ACC4 (W2027S)
ANSGARIGIADEVKSCFRVGWSDEGSPERGFQYIYLTEEDYARISSSVIAHKLQLDSGEIRWIIDSVVGKEDGLGVENIHGSAAIASAYSRAYEETFTLTFVTGRTVGIGAYLARLGIRCIQRLDQPIILTGFSALNKLLGREVYSSHMQLGGPKIMATNGVVHLTVPDDLEGVSNILRWLSYVPANIGGPLPITKPLDPPDRPVAYIPENTCDPRAAIRGVDDSQGKWLGGMFDKDSFVETFEGWAKTVVTGRAKLGGIPVGVIAVETQTMMQLVPADPGQLDSHERSVPRAGQVWFPDSATKTAQALLDFNREGLPLFILANSRGFSGGQRDLFEGILQAGSTIVENLRTYNQPAFVYIPMAGELRGGAWVVVDSKINPDRIECYAERTAKGNVLEPQGLIEIKFRSEELQDCMGRLDPELINLKAKLQDVKHGNGSLPDIESLQKSIEARTKQLLPLYTQIAIRFAELHDTSLRMAAKGVIKKVVDWEESRSFFYKRLRRRISEDVLAKEIRHIVGDNFTHQSAMELIKEWYLASPATAGSTGWDDDDAFVAWKDSPENYNGYIQELRAQKVSQSLSDLTDSSSDLQAFSQGLSTLLDKMDPSQRAKFVQEVKKVLG